(19) United States
(12) Patent Application Publication
(10) Pub. No.: US 2013/0226619 A1
(43) Pub. Date: Aug. 29, 2013

(54) INPUT SUPPORT DEVICE AND INPUT SUPPORT METHOD

(71) Applicant: FUJITSU LIMITED, (US)

(72) Inventor: Kiyoshi TAKEUCHI, Kanazawa (JP)

(73) Assignee: FUJITSU LIMITED, Kawasaki-shi (JP)

(21) Appl. No.: 13/856,845

(22) Filed: Apr. 4, 2013

Related U.S. Application Data
(63) Continuation of application No. PCT/JP2011/073925, filed on Oct. 18, 2011.

(30) Foreign Application Priority Data
Oct. 19, 2010 (JP) 2010-234964

(51) Int. Cl. G06F 19/00

(52) U.S. Cl. CPC G06F 19/322
USPC 705/3

(57) ABSTRACT

An input support device includes an acquisition unit configured to acquire an attribute of a first document that is an input target of a user, and acquire a second document corresponding to the acquired attribute from a storage unit storing the attribute and the second document relevant to the attribute; a first determination unit configured to determine whether a sentence example, which is stored beforehand in association with reading information, is included in the second document; and a second determination unit configured to determine a display format of the sentence example to be displayed together with the first document when a character string included in the reading information is input to the first document by the user, based on a determination result of the first determination unit.

### CROSS-REFERENCE TO RELATED APPLICATION

This application is a U.S. continuation application filed under 35 USC 111(a) claiming benefit under 35 USC 120 and 365(c) of PCT application JP2011/073925 filed in Japan on Oct. 18, 2011 which claims priority to Japanese Patent Application No. 2010-234964 filed in Japan on Oct. 19, 2010. The foregoing application is hereby incorporated herein by reference.

### FIELD

The embodiments discussed herein are related to an input support device and an input support method, and more particularly to an input support device and an input support method for supporting input of documents.

### BACKGROUND

Conventionally, when creating documents with a personal computer (PC), kana-kanji conversion software (for converting Japanese kana characters into Japanese kanji characters) is used to input character strings. Generally, kana-kanji conversion software includes a dictionary used for kana-kanji conversion, and in response to input of characters (kana characters) that indicate the reading of a kanji character, character strings of kanji characters corresponding to the reading are searched for in the dictionary, and the character strings that have been found are presented as conversion candidates. The ease of using kana-kanji conversion software is largely dependent on the order of displaying the conversion candidates. Thus, conventionally, various methods relevant to the display order of conversion candidates have been devised. For example, Patent Document 1 discusses a technology of preferentially displaying conversion candidates that have been used frequently in the past, and also preferentially displaying conversion candidates that have been frequently used recently.
Patent document 1: Japanese Laid-Open Patent Publication No. H7-56913

However, the preference level of conversion candidates that match the same reading may differ according to the document that is the editing target. That is to say, even if a certain conversion candidate has a low usage frequency in inputting all kinds of documents, this conversion candidate may have a high preference level for a user inputting a particular kind of document.

For example, in medical institutions, an electronic medical record system is used for managing information relevant to medical care and medical treatment of patients. In an electronic medical record system, a document referred to as an electronic medical record is managed for each patient, and the user (doctor, nurse, accounting clerk, etc.) who has performed the medical care, etc., for the patient inputs information in the electronic medical record of the patient.

In this case, character strings used for the electronic medical record of a patient A and character strings used for the electronic medical record of a patient B may be largely different. This is because the illness history and medical care history are different for each patient.

Specifically, when inputting information in an electronic medical record of a patient A who has pneumonia (“haien” in Japanese), when “hai” is input, character strings relevant to pneumonia (“haien”) are preferably displayed. Meanwhile, when inputting information in an electronic medical record of a patient B who has pulmonary tuberculosis (“haikekkaku” in Japanese), when “hai” is input, character strings relevant to pulmonary tuberculosis (“haikekkaku”) are preferably displayed.

However, as in Patent Document 1, when the display order is determined simply on the usage frequency, if the usage frequency relevant to pulmonary tuberculosis is high, when “hai” is input to the electronic medical record of the patient A, character strings relevant to pulmonary tuberculosis are displayed as top ranking conversion candidates. Consequently, it takes time to find a character string that the user has intended to input.

This kind of problem may also arise when inputting information into documents other than electronic medical records.

### SUMMARY

According to an aspect of the embodiments, a non-transitory computer-readable recording medium stores an input support program that causes a computer to execute a process including acquiring an attribute of a first document that is an input target of a user; acquiring a second document corresponding to the acquired attribute from a storage unit storing the attribute and the second document relevant to the attribute; determining whether a sentence example, which is stored beforehand in association with reading information, is included in the second document; and determining a display format of the sentence example to be displayed together with the first document when a character string included in the reading information is input to the first document by the user, based on a result of the determining of whether the sentence example is included in the second document.

The object and advantages of the invention will be realized and attained by means of the elements and combinations particularly pointed out in the appended claims. It is to be understood that both the foregoing general description and the following detailed description are exemplary and explanatory and are not restrictive of the invention as claimed.

### BRIEF DESCRIPTION OF THE DRAWINGS

FIG. 1 illustrates a configuration of an electronic medical record system according to an embodiment of the present invention;

FIG. 2 illustrates a hardware configuration of an electronic medical record terminal according to an embodiment of the present invention;

FIG. 3 is a functional block diagram of an electronic medical record system according to an embodiment of the present invention;

FIG. 4 is a flowchart for describing an example of processing procedures of an electronic medical record editing process;

FIG. 5 illustrates a configuration example of an electronic medical record work area;

FIG. 6 is a flowchart for describing an example of processing procedures of an initialization process performed by an input support unit;

FIG. 7 illustrates a configuration of a user sentence example dictionary;

FIG. 8 is a flowchart for describing an example of processing procedures of a sentence example display/input process;

FIG. 9 illustrates a display example of a list of sentence examples;

FIG. 10 is a flowchart for describing an example of processing procedures of an ending process performed by an input support unit; and

FIG. 11 illustrates sentence example dictionaries for each genre.

### DESCRIPTION OF EMBODIMENTS

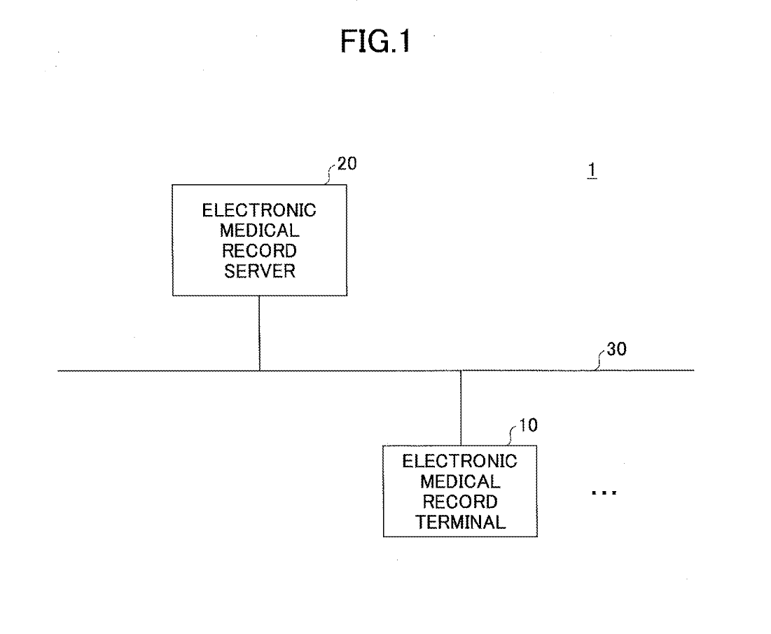

Preferred embodiments of the present invention will be explained with reference to accompanying drawings. FIG. 1 illustrates a configuration of an electronic medical record system according to an embodiment of the present invention. In an electronic medical record system 1 illustrated in FIG. 1, at least one electronic medical record terminal 10 and an electronic medical record server 20 are connected so that communication is possible, via a network 30 (wired or wireless) such as a LAN (Local Area Network) or the Internet.

The electronic medical record server 20 is a computer for managing electronic medical records. An electronic medical record is document data in which medical care information of a patient is recorded. Therefore, an electronic medical record is managed for each patient. In the present embodiment, an electronic medical record is an example of a document (electronic document).

The electronic medical record terminal 10 is a computer such as a PC (Personal Computer) used for inputting information in an electronic medical record. A mobile type terminal such as a mobile phone, a PDA (personal digital assistance), or a smart-phone may be used as the electronic medical record terminal 10. In the present embodiment, the electronic medical record terminal 10 is an example of an input support device.

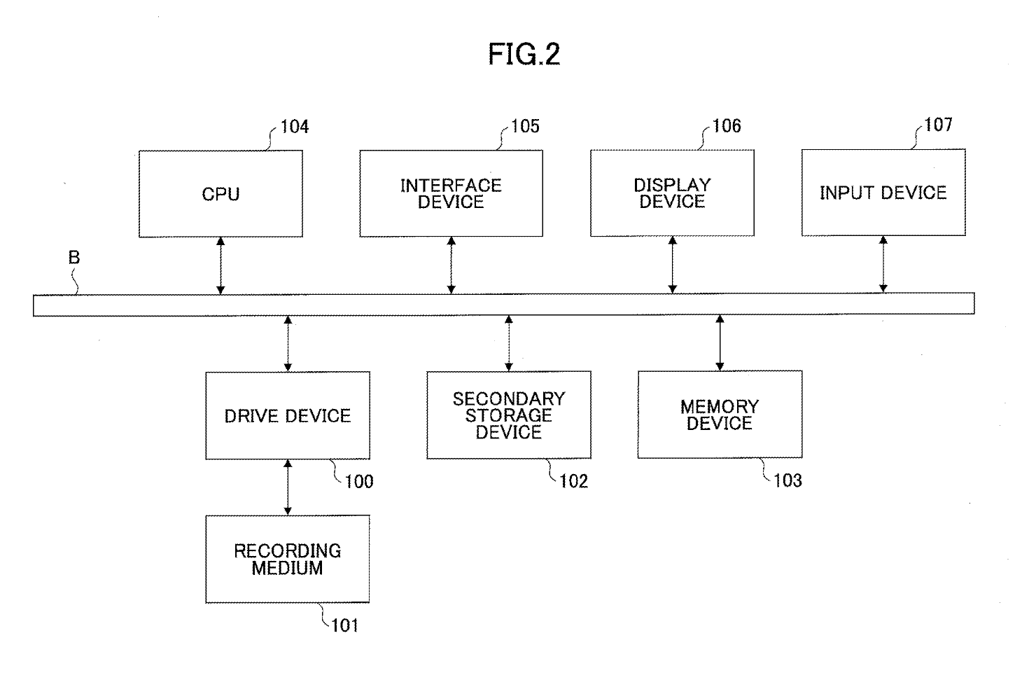

FIG. 2 illustrates a hardware configuration of an electronic medical record terminal according to an embodiment of the present invention. The electronic medical record terminal 10 illustrated in FIG. 2 includes a drive device 100, a secondary storage device 102, a memory device 103, a CPU 104, an interface device 105, a display device 106, and an input device 107, which are connected to each other by a bus B.

A program for realizing a process at the electronic medical record terminal 10 is provided by a recording medium 101. When the recording medium 101 recording the program is set in the drive device 100, the program is installed in the secondary storage device 102 via the drive device 100 from the recording medium 101. However, the program does not always have to be installed from the recording medium 101; the program may be downloaded from another computer via a network. The secondary storage device 102 stores the installed program as well as files and data.

The memory device 103 reads a program from the secondary storage device 102 and stores the program, when an instruction to activate the program is given. The CPU 104 realizes functions relevant to the electronic medical record terminal 10 according to programs stored in the memory device 103. The interface device 105 is used as an interface for connecting to a network. The display device 106 displays a GUI (Graphical User Interface) according to a program. The input device 107 includes a keyboard and a mouse, and is used for inputting various operation instructions.

Examples of the recording medium 101 are portable recording media such as a CD-ROM, a DVD disk, and a USB memory. Examples of the secondary storage device 102 are a HDD (Hard Disk Drive) and a flash memory. Both the recording medium 101 and the secondary storage device 102 are computer-readable recording media.

The electronic medical record server 20 may also have the same hardware as that illustrated in FIG. 2. However, the electronic medical record server 20 does not have to include the display device 106 and the input device 107.

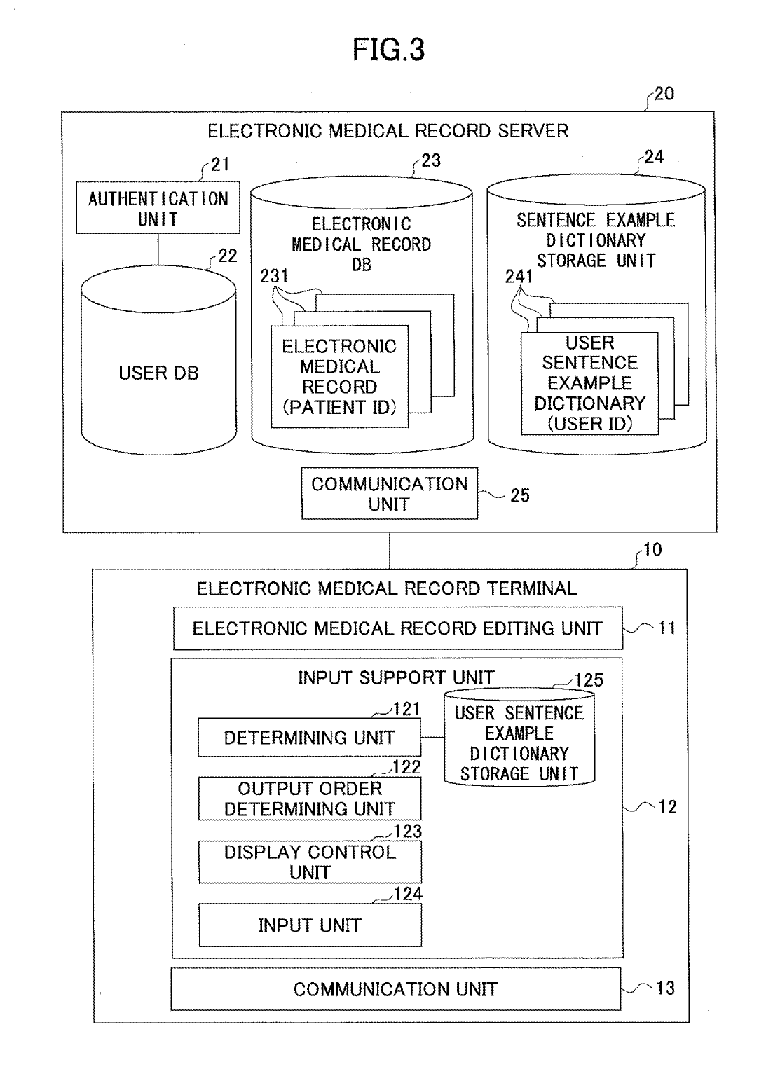

FIG. 3 is a functional block diagram of the electronic medical record system according to an embodiment of the present invention. As illustrated in FIG. 3, the electronic medical record server 20 includes an authentication unit 21, a user DB 22, an electronic medical record DB 23, a sentence example dictionary storage unit 24, and a communication unit 25.

The authentication unit 21 authenticates the user of the electronic medical record system 1. The user DB 22 stores attribute information of each user of the electronic medical record system 1 by using a storage device of the electronic medical record server 20. The attribute information includes authentication information such as the user ID (user identifier) and a password. The authentication information is used by the authentication unit 21. The user of the electronic medical record system 1 is, for example, a doctor, a nurse, and an accounting clerk.

The electronic medical record DB 23 stores an electronic medical record 231 by using a storage device of the electronic medical record server 20. The electronic medical record 231 is stored in association with an identifier of a patient (patient ID) to which the electronic medical record 231 corresponds. Each electronic medical record 231 may be associated with a user ID of the user who edited (wrote) the electronic medical record 231. The storage format of the electronic medical record 231 is not limited to a predetermined format. The electronic medical record 231 may be, for example, a record of a database or a document file.

The sentence example dictionary storage unit 24 stores a user sentence example dictionary 241 for each user, by using the secondary storage device of the electronic medical record server 20. For example, the user sentence example dictionary 241 is associated with a user ID. The user sentence example dictionary 241 is data in which sentence examples are recorded in association with the reading of the sentence examples. A sentence example is an assembly of one or more sentences. However, in the user sentence example dictionary 241, a sentence example does not always have to be associated with the reading. A word may be associated with the reading, as in the case of typical kana-kanji conversion software.

The communication unit 25 controls communications with the electronic medical record terminal 10.

The electronic medical record terminal 10 includes an electronic medical record editing unit 11, an input support unit 12, and a communication unit 13. The electronic medical record editing unit 11 is a browser or an editor of the electronic medical record 231. The electronic medical record editing unit 11 displays and edits the electronic medical record 231 according to edit instructions input by the user. In the present embodiment, the electronic medical record editing unit 11 is an example of an acquisition unit.

The communication unit 13 controls communications with the electronic medical record server 20.

The input support unit 12 supports the inputting or the editing in the electronic medical record 231 by the user, with the use of the user sentence example dictionary 241. As illustrated in FIG. 3, the input support unit 12 includes a determining unit 121, an output order determining unit 122, a display control unit 123, an input unit 124, and a user sentence example dictionary storage unit 125.

The user sentence example dictionary storage unit 125 is a storage area (for example, a predetermined folder or directory) in the secondary storage device 102 for storing the user sentence example dictionary 241 that has been downloaded from the electronic medical record server 20.

The determining unit 121 determines, for each sentence example included in the user sentence example dictionary 241 stored in the user sentence example dictionary storage unit 125, whether there is a matching character string in the electronic medical record 231 that is the editing target. To a sentence example having a matching character string in the electronic medical record 231 that is the editing target, the determining unit 121 attaches flag information indicating that effect (priority flag described below).

The output order determining unit 122 determines the output order of sentence examples output as input candidates (conversion candidates) according to input of the reading when editing the electronic medical record 231. More specifically, among the sentence examples stored in the user sentence example dictionary 241 in association with sentence examples corresponding to the input reading or an undetermined character string, the output order determining unit 122 determines the output order of a sentence example to which a priority flag is attached to be at a higher rank than a sentence example to which a priority flag is not attached. In the present embodiment, the output order determining unit 122 is an example of a display format determination unit.

The display control unit 123 displays a list of sentence examples corresponding to the input reading, in an output order determined by the output order determining unit 122. The input unit 124 inputs a sentence example selected from the list of sentence examples, in the electronic medical record 231.

The electronic medical record editing unit 11 and the input support unit 12 may be realized by separate programs that are independent from each other. For example, the electronic medical record editing unit 11 may be realized by a process that an electronic medical record editing program causes the CPU 104 to execute, and the input support unit 12 may be realized by a process that an input support program causes the CPU 104 to execute. In this case, the electronic medical record editing unit 11 and the input support unit 12 are activated as separate processes that are independent from each other. Therefore, between the electronic medical record editing unit 11 and the input support unit 12, communications are performed by inter-process communications.

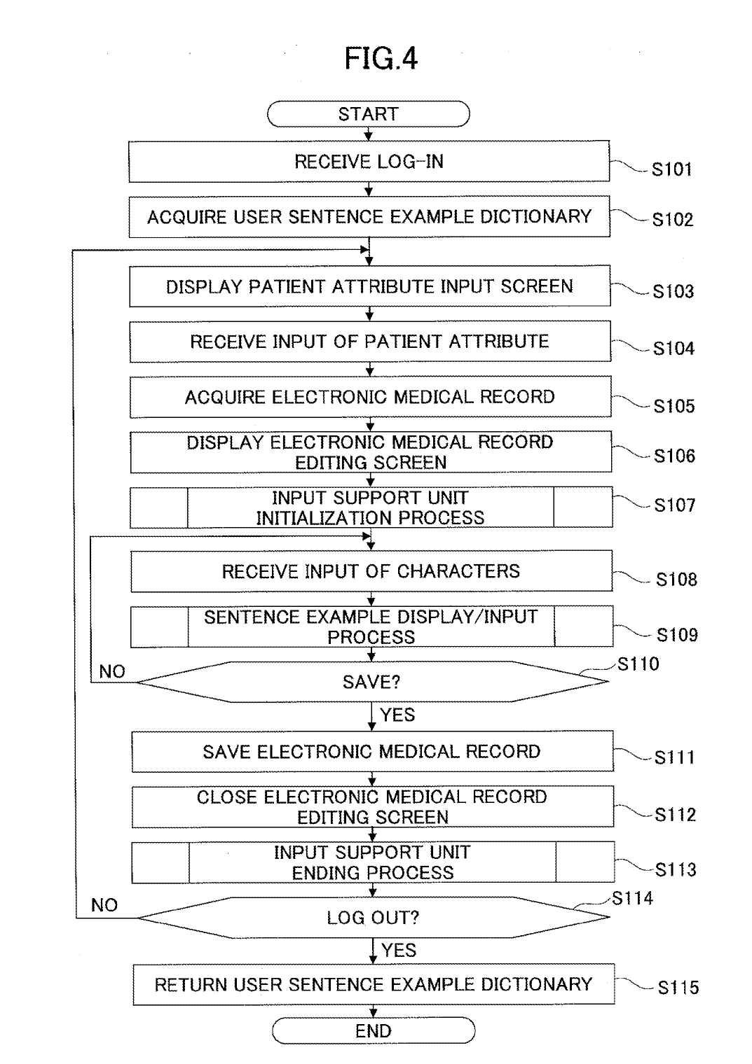

In the following, a description is given of processing procedures of the electronic medical record terminal 10. FIG. 4 is a flowchart for describing an example of processing procedures of an electronic medical record editing process.

In step S101, the electronic medical record editing unit 11 receives log-in from a user. Specifically, the electronic medical record editing unit 11 causes the display device 106 to display a log-in screen. The electronic medical record editing unit 11 receives input of a user ID and a password via the log-in screen. The electronic medical record editing unit 11 sends an authentication request including the input user ID and password, to the authentication unit 21 of the electronic medical record server 20. The authentication unit 21 performs an authentication process by matching the user ID and password included in the authentication request with the user ID and password registered in the user DB 22. The authentication unit 21 returns the authentication result to the electronic medical record editing unit 11. When the authentication result indicates that the authentication is unsuccessful, the electronic medical record editing unit 11 cancels further processing. When the authentication result indicates that the authentication is successful, the electronic medical record server 20 records, in the memory device 103, the user ID input to the log-in screen as the user ID of the log-in user (hereinafter, “log-in user ID”), and continues further processing.

Next, the electronic medical record editing unit 11 acquires (downloads) the user sentence example dictionary 241 of the log-in user from the sentence example dictionary storage unit 24 of the electronic medical record server 20 (step S102). That is to say, the user sentence example dictionary 241 associated with the user ID matching the log-in user ID in the sentence example dictionary storage unit 24 is acquired. The electronic medical record editing unit 11 records the acquired user sentence example dictionary 241 in the user sentence example dictionary storage unit 125. Here, the electronic medical record editing unit 11 is recognizing or planning to use the input support unit 12. Specifically, in the electronic medical record editing unit 11, the position (folder or directory) of the user sentence example dictionary storage unit 125 in the secondary storage device 102 is set in advance. When the relationship between the electronic medical record terminal 10 and the user is one-on-one, each electronic medical record terminal 10 may store the user sentence example dictionary 241 corresponding to the user of the electronic medical record terminal 10 in advance. A format where the user sentence example dictionary 241 is downloaded from the electronic medical record server 20 as in the present embodiment is particularly effective when each user uses a plurality of electronic medical record terminals 10. This is because each user is able to use the user sentence example dictionary 241 corresponding to himself, regardless of which electronic medical record terminal 10 he is using.

Next, the electronic medical record editing unit 11 causes the display device 106 to display a patient attribute input screen (step S103). Next, the electronic medical record editing unit 11 receives, from the user, input of attribute information of the patient for identifying the patient, via the patient attribute input screen (step S104). For example, input of the patient ID is received. The patient relevant to the input patient ID is hereinafter referred to as “target patient”.

Next, the electronic medical record editing unit 11 acquires (downloads) the electronic medical record 231 of the target patient from the electronic medical record DB 23 of the electronic medical record server 20 (step S105). That is to say, the electronic medical record 231 associated with the patient ID of the target patient in the electronic medical record DB 23 is acquired. The electronic medical record editing unit 11 loads (records) the acquired electronic medical record 231 in the electronic medical record work area. The electronic medical record work area is the area storing the electronic medical record 231 that is the editing target, in the memory device 103 or the secondary storage device 102.

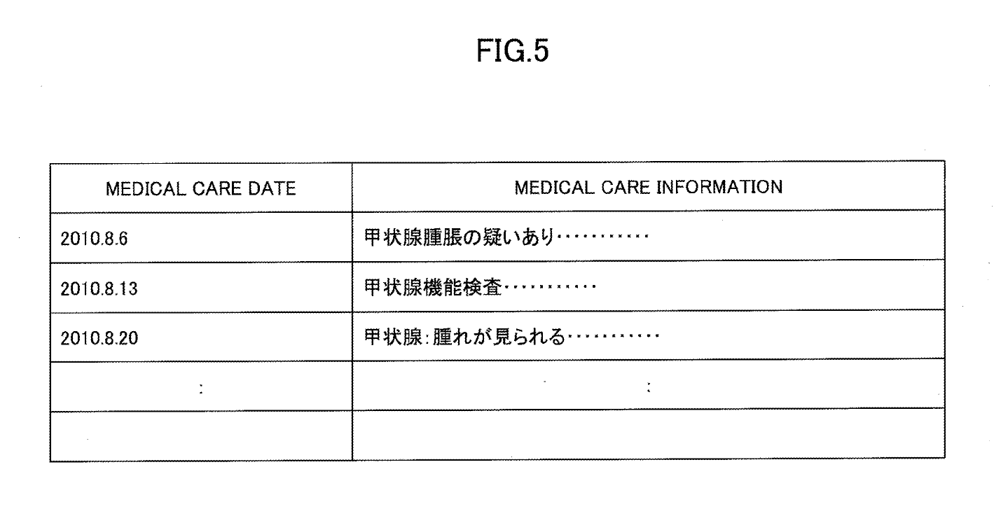

FIG. 5 illustrates a configuration example of the electronic medical record work area. In the electronic medical record work area of FIG. 5, medical care information of each medical care instance is recorded for each target patient by the corresponding medical care date. The medical care information is also referred to as a medical care record, which is written in the electronic medical record 231. In the present embodiment, it is assumed that all records indicated in FIG. 5 are included in a single electronic medical record 231 corresponding to the target patient. The medical care information is indicated in the right column in Japanese kanji characters and kana characters.

Next, the electronic medical record editing unit 11 causes the display device 106 to display an electronic medical record editing screen (step S106). In the electronic medical record editing screen, contents of the electronic medical record work area are displayed in a state that may be edited in a predetermined layout.

Next, the electronic medical record editing unit 11 requests the input support unit 12 to execute an initialization process. The input support unit 12 executes an initialization process in response to the request (call) from the electronic medical record editing unit 11 (step S107).

Next, the electronic medical record editing unit 11 receives input of a character string to the electronic medical record 231 in the electronic medical record editing screen (step S108). The input support unit 12 detects input of the character string, and executes a sentence example display/input process (step S109). In the sentence example display/input process, assuming that the input character string is a reading, a list of sentence examples corresponding to the reading (hereinafter, “sentence example list”) is displayed, and a sentence example selected from the sentence example list is input to the electronic medical record 231. The input sentence example is applied to the electronic medical record work area. For example, in the electronic medical record work area, a new record corresponding to the present day is added, and the input sentence example is added to the medical care information of the new record.

Steps S108 and S109 are repeated until a save instruction is input to the electronic medical record editing screen (step S110). When a save instruction is input (YES in step S110), the electronic medical record editing unit 11 executes a save process of the electronic medical record 231 (step S111). Specifically, the electronic medical record editing unit 11 specifies the patient ID of the target patient, and uploads (transfers) the contents in the electronic medical record work area to the electronic medical record DB 23 of the electronic medical record server 20. As a result, in the electronic medical record DB 23, the electronic medical record 231 corresponding to the patient ID of the target patient is updated by the contents in the electronic medical record work area.

Next, the electronic medical record editing unit 11 closes the electronic medical record editing screen (step S112). That is to say, the electronic medical record editing screen is not displayed. Next, the electronic medical record editing unit 11 requests the input support unit 12 to execute an ending process. The input support unit 12 executes an ending process in response to the request (call) from the electronic medical record editing unit 11 (step S113).

Next, when the electronic medical record 231 of another patient is to be edited (NO in step S114), step S103 and onward are repeated. Meanwhile, when an instruction to log out is input (YES in step S114), the electronic medical record editing unit 11 specifies a log-in user ID and uploads (transfers) the user sentence example dictionary 241 recorded in the user sentence example dictionary storage unit 125 to the sentence example dictionary storage unit 24 of the electronic medical record server 20. As a result, the user sentence example dictionary 241 corresponding to the user ID is updated in the sentence example dictionary storage unit 24. The user sentence example dictionary 241 is uploaded because contents of the user sentence example dictionary 241 may be updated in the sentence example display/input process as described below.

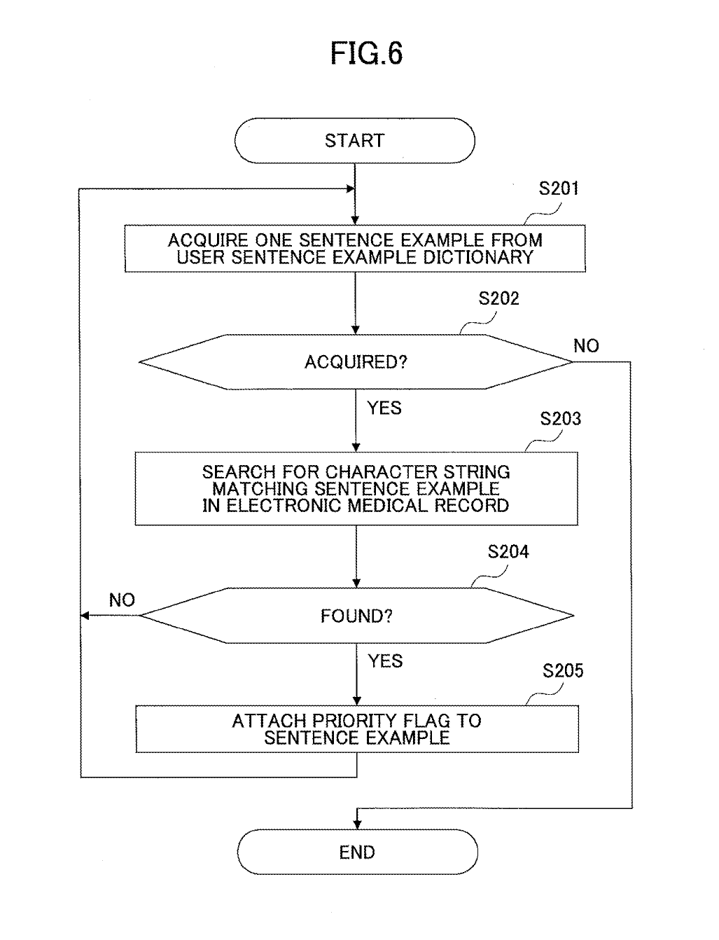

Next, details of step S107 are described. FIG. 6 is a flowchart for describing an example of processing procedures of an initialization process performed by the input support unit 12.

In step S201, the determining unit 121 of the input support unit 12 acquires one sentence example from a user dictionary stored in the user sentence example dictionary storage unit 125.

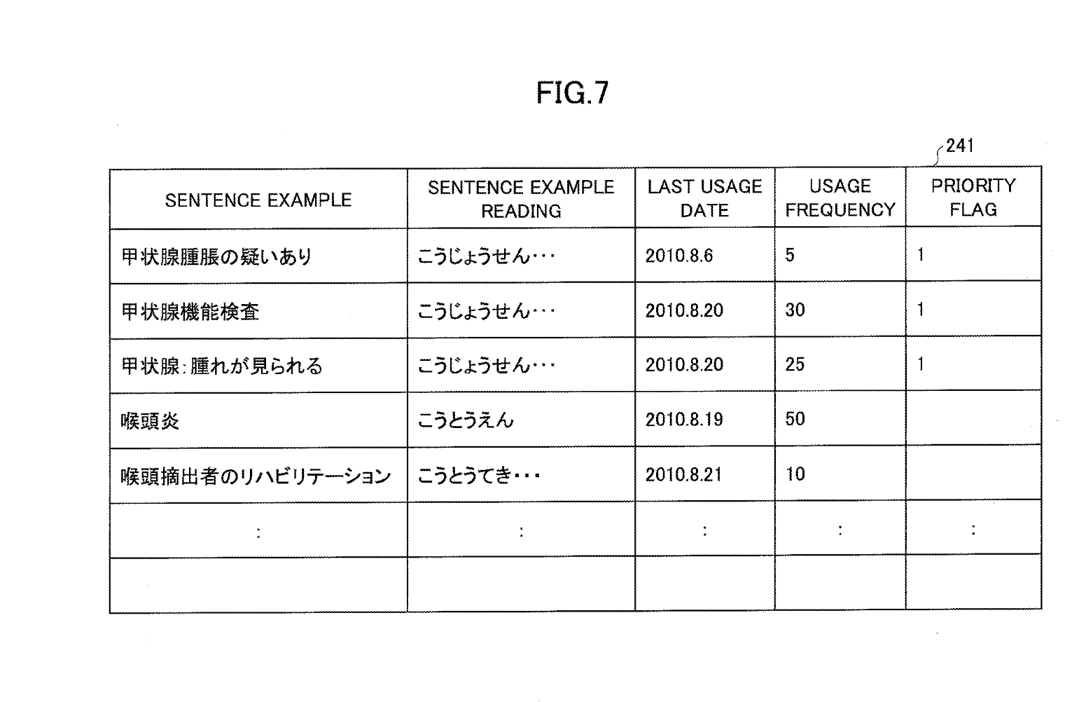

FIG. 7 illustrates a configuration of the user sentence example dictionary. In FIG. 7, the user sentence example dictionary 241 includes, for each sentence example, information such as a “sentence example reading”, the last usage date (last usage time), the usage frequency, and a priority flag. The sentence example is a sentence or an assembly of sentences input to the electronic medical record 231 (in the far left column in FIG. 7, indicated in Japanese kanji characters and kana characters). The sentence example reading is the reading (in Japanese kana characters) of the sentence example (in the second column from the left in FIG. 7, indicated in Japanese kana characters). The last usage date is the date (time) when the sentence example was used last (selected as the input target). The usage frequency is the frequency (number of times) that the sentence example has been used (selected as an input target). The priority flag is a flag indicating whether the sentence example is prioritized in the output order of sentence examples. Before executing the process of FIG. 6, there are no sentence examples having a priority flag attached. In the present embodiment, the sentence example reading is an example of a first character string. The sentence example is an example of a second character string.

In step S201 described above, one sentence example is acquired from the user sentence example dictionary 241 as illustrated in FIG. 7.

Next, the determining unit 121 determines whether a sentence example is acquired (step S202). That is to say, the determining unit 121 determines whether there are any unprocessed sentence examples remaining relevant to the process of FIG. 6. When a sentence example is acquired (YES in step S202), the determining unit 121 searches for a character string matching the acquired sentence example (hereinafter, “target sentence example”) from all medical care information items in the electronic medical record work area (step S203). In this example, matching means to completely match. In another example, it may be determined whether there is a sentence or an assembly of sentences having the same meaning as the sentence example.

The searching for a character string matching the target sentence example is executed in an order starting from a medical care information item of the latest date. When a matching character string is found in any one of the medical care information items, the searching operation relevant to the target sentence example is to be ended at this time point. By ending the searching at the time point when a character string matching the target sentence example is found, the searching time is reduced. Furthermore, the medical care date of the time point when a character string is found may be recorded in the memory device 103 in association with the target sentence example, and this medical care date may be used for determining the output order of sentence examples described below. The medical care date means the date when the target sentence example had been used the last time, with respect to the electronic medical record 231 that is the editing target.

When a character string matching the target sentence example is found (YES in step S204), the determining unit 121 attaches a priority flag to the target sentence example (step S205). That is to say, “1” is recorded in the priority flag of the record relevant to the target sentence example in the user sentence example dictionary 241. In the user sentence example dictionary 241 in FIG. 7, “1” is recorded in the priority flags of the records from the first to third lines. This is because the character string matching the sentence example of each of these records is included in one of the medical care information items in the electronic medical record work area of FIG. 5 of the target patient. That is to say, the fourth and fifth records indicate a sentence example that has never been used in the past medical care information of the target patient.

Steps S201 through S205 are executed for all sentence examples included in the user sentence example dictionary 241. When the process is completed for all sentence examples (NO in step S202), the determining unit 121 ends the initialization process.

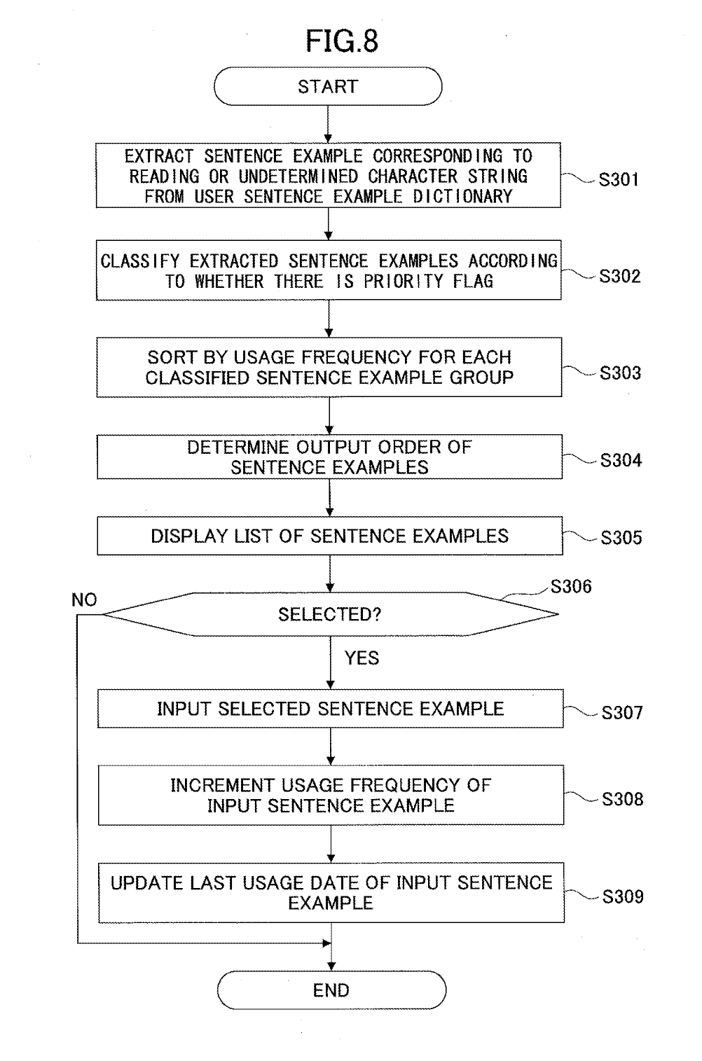

Next, a description is given of details of step S109 of FIG. 4. FIG. 8 is a flowchart for describing an example of processing procedures of a sentence example display/input process.

In step S301, the output order determining unit 122 of the input support unit 12 extracts a sentence example corresponding to the reading or the undetermined character string from the user sentence example dictionary 241 stored in the user sentence example dictionary storage unit 125. A sentence example corresponding to the reading or the undetermined character string means a sentence example whose corresponding “sentence example reading” matches the reading, or a sentence example itself matching the undetermined character string. A “sentence example reading” matching the input reading corresponds to, for example, a “sentence example reading” in which the input reading is included at the beginning. This includes a case where the input reading completely matches the “sentence example reading”, and a case where part of the beginning of the “sentence example reading” matches the input reading. Furthermore, a sentence example matching the undetermined character string corresponds to, for example, a sentence example in which the undetermined character string is included at the beginning. A case where the undetermined character string and the sentence example completely match is included, and a case where part of the beginning of the sentence example matches the undetermined character string is included. An undetermined character string is a character string that has been obtained by converting the input reading with a kana-kanji conversion software (not illustrated) but has not yet been determined to be input.

Therefore, the contents of the process of the output order determining unit 122 at step S301 are as follows.

In response to the input of the reading, the output order determining unit 122 extracts a sentence example corresponding to the “sentence example reading” matching the reading. When the reading is converted into an undetermined character string, the output order determining unit 122 extracts a sentence example matching the undetermined character string.

Next, the output order determining unit 122 classifies the extracted sentence examples into two assemblies (groups) according to whether there is a priority flag (step S302). That is to say, the extracted sentence examples are classified into two groups, i.e., a group of sentence examples having a priority flag (hereinafter, “priority sentence example group”) and a group of sentence examples without a priority flag (hereinafter, “non-priority sentence example group”).

Next, the output order determining unit 122 sorts the sentence examples in a descending order of usage frequency, in both the priority sentence example group and the non-priority sentence example group (step S303). That is to say, the sentence examples are sorted so that the sentence examples having relatively high usage frequencies are ranked at the top. Alternatively, sentence examples having the same usage frequency may be sorted in a descending order of the last usage date. That is to say, the sentence examples having more recent last usage dates are ranked at the top. Alternatively, sentence examples having the same usage frequency may be sorted in a descending order of the medical care date of the medical care information in which a character string matching the sentence example has been found. In this case, the sentence examples are likely to be sorted in a more appropriate order according to the electronic medical record 231 that is presently the editing target. That is to say, the last usage date in the user sentence example dictionary 241 is the date when the sentence example has been used last with respect to electronic medical records 231 of plural patients. Meanwhile, the medical care date of the medical care information in which a character string matching the sentence example has been found is the date on which the sentence example has been used last with respect to the electronic medical record 231 that is presently the editing target.

When the sentence examples are sorted according to the last usage date in units of days, there may be sentence examples that are ranked at the same order. Therefore, instead of using the last usage date, a last usage time may be recorded in the user sentence example dictionary 241.

Next, the output order determining unit 122 determines the output order of the sentence examples (step S304). Specifically, the output order determining unit 122 determines the output order of the sentence examples so that the priority sentence example group is ranked higher than the non-priority sentence example group. Thus, the sentence example having the highest usage frequency in the priority sentence example group is the topmost ranked sentence example. Furthermore, the sentence example having the highest usage frequency in the non-priority sentence example group is ranked next to the sentence example having the lowest usage frequency in the priority sentence example group.

Next, the display control unit 123 causes the display device 106 to display the list of sentence examples according to the output order determined by the output order determining unit 122 (step S305).

The display format of the sentence examples determined based on priority flags, last usage dates, and usage frequencies, is not limited to the output order. For example, it is possible to use a display format in which a sentence example determined to be preferentially displayed is displayed by highlighting the background color.

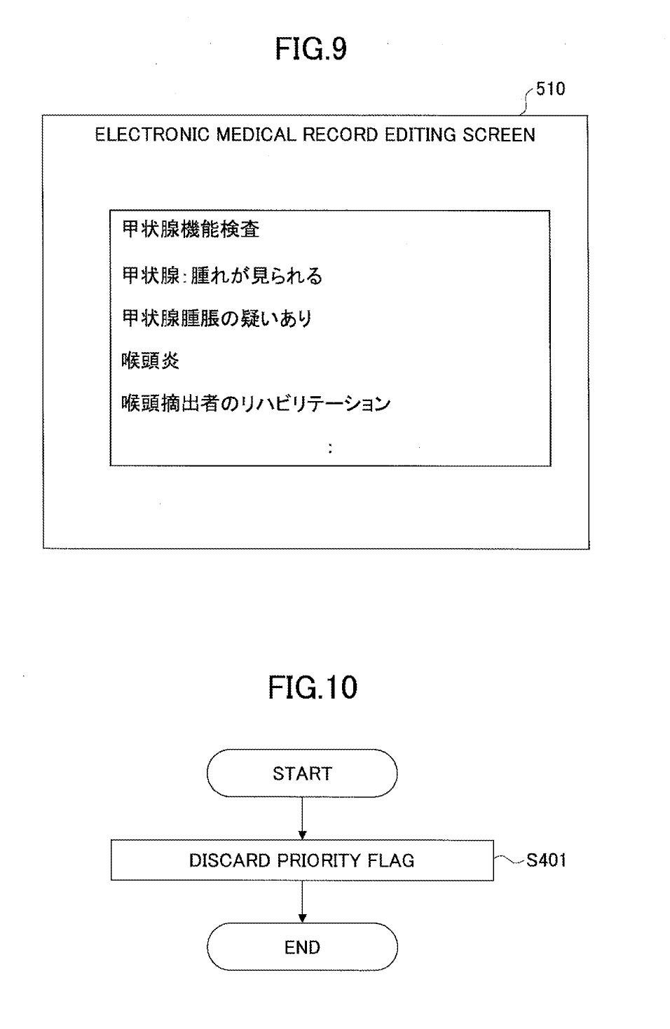

FIG. 9 illustrates a display example of a list of sentence examples (indicated in Japanese kanji characters and kana characters). FIG. 9 illustrates an example of a list of sentence examples displayed based on the electronic medical record work area illustrated in FIG. 5 and the user sentence example dictionary 241 illustrated in FIG. 7, when a reading “kou” is input.

As illustrated in FIG. 9, the display control unit 123 displays the list of sentence examples to be superposed on an electronic medical record editing screen 510 (that is to say, in a electronic medical record work area). By displaying the list of sentence examples in this format, the load of inputting information in the electronic medical record is further reduced.

According to the medical care information in the electronic medical record work area in FIG. 5, it is recognized that the target patient is a patient relevant to thyroid gland. Therefore, when the user inputs “kou”, it is assumed that the user is highly likely to input a sentence example starting with “koujousen” (Japanese word meaning thyroid gland). In the list of sentence examples illustrated in FIG. 9, sentence examples relevant to “koujousen” (thyroid gland) are displayed at high ranks. That is to say, sentence examples that are assumed to be highly likely to be input by the user are displayed at the top.

Next, when the user selects one sentence example from the list of sentence examples (step S306), the input unit 124 inputs the selected sentence example in the electronic medical record 231 (step S307). More precisely, the selected sentence example is applied (recorded) in the electronic medical record work area. As a result, contents of the electronic medical record editing screen 510 are updated. In the present embodiment, a sentence example relevant to “koujousen” (thyroid gland) is highly likely to be selected. Therefore, the user is highly likely to easily select the sentence example that he wants to input, from the list of sentence examples. Particularly, as the sentence examples are sorted according to the usage frequency in the priority sentence example group, the user is highly likely to be able to find the desired sentence example from the sentence examples displayed at the top.

Next, the input unit 124 adds one to the value of the usage frequency corresponding to the input sentence example, in the user sentence example dictionary 241 (step S308). Next, the input unit 124 updates the last usage date corresponding to the input sentence example to the present date, in the user sentence example dictionary 241 (step S309).

Next, details of step S113 of FIG. 4 are described. FIG. 10 is a flowchart for describing an example of processing procedures of an ending process performed by the input support unit 12.

In step S401, the determining unit 121 removes (clears) all priority flags attached to the sentence examples in the user sentence example dictionary 241 stored in the user sentence example dictionary storage unit 125. This is because the priority flag is effective for the electronic medical record 231 that has been edited up until now. That is to say, if the editing target is changed to another electronic medical record 231, the sentence example to which priority flags are attached may change.

As described above, according to the present embodiment, for each electronic medical record 231, the output order of sentence examples in the list of sentence examples (list of sentence examples that are input candidates) may be changed to an order appropriate for the electronic medical record 231 with respect to the input operations of the target patient. Therefore, compared to the case where the output order of sentence examples is determined based on all of the past usage frequencies by users, the load of performing input operations in the electronic medical record 231 is expected to be further reduced. Specifically, the user is able to find the desired sentence example ranking at a higher position in the displayed list of sentence examples, and quickly select the desired sentence example.

As the sentence example is selected more quickly, the load of the CPU 104 is expected to be alleviated and the memory consumption amount is expected to be reduced. That is to say, the sentence examples displayed in the list of sentence examples that are input candidates change from moment to moment according to the progress of inputting the reading. Specifically, at the time point when the second character is input, sentence examples including these two characters at the beginning are the input candidates, but at the time point when three characters are input, the input candidates are narrowed down to sentence examples including these three characters at the beginning. The CPU 104 repeats such a narrowing-down process until input of character strings is determinated by the user.

According to the present embodiment, at the stage when the number of characters of the reading input by the user is small, the desired sentence example is displayed at a high rank, and the user is highly likely to select the desired sentence example. As a result, it is possible to mitigate an increase in the load of the CPU 104 and an increase in the memory consumption amount which may otherwise be caused by repeating the above narrowing-down process.

Furthermore, as the sentence example is selected more quickly, the display time of the list of sentence examples is also reduced. As a result, the load of the CPU 104 and the memory consumption amount used for displaying the list of sentence examples are reduced.

In the present embodiment, the user sentence example dictionary 241 is different for each user. However, a single user sentence example dictionary 241 may be shared by plural users. For example, in a medical institution such as a hospital, it is anticipated that the sentence examples used may differ according to the department of diagnosis and treatment. Therefore, one user sentence example dictionary 241 may be created for each department. In this case, for example, the user DB 22 stores the department of the user for each user. When a user is authenticated by an authentication process of the user, the authentication unit 21 returns attribute information of the user to the electronic medical record editing unit 11. The electronic medical record editing unit 11 downloads the user sentence example dictionary 241 corresponding to the department included in the attribute information.

Alternatively, the user sentence example dictionary 241 may be shared among plural medical institutions. That is to say, the electronic medical record server 20 may be shared among plural medical institutions.

Furthermore, a program realizing the input support unit 12 does not have to be installed in the electronic medical record terminal 10 in advance. For example, the input support program may be included in part of a web page. For example, the web page edits documents managed in the website, and the input support unit 12 presents sentence examples appropriate for a document that is the editing target in the web page. This kind of format is preferable for cloud computing of recent years. In this case, the user sentence example dictionary 241 is to be stored in the website, and does not have to be downloaded to the client side. The input support unit 12 is to access the user sentence example dictionary 241 via the network.

In this case, a website corresponds to the electronic medical record server 20 according to the present embodiment. The client side corresponds to the electronic medical record terminal 10 according to the present embodiment. Also in the present embodiment, the user sentence example dictionary 241 does not have to be downloaded in the electronic medical record terminal 10. However, if the user sentence example dictionary 241 is downloaded to the electronic medical record terminal 10 as in the present embodiment, the speed of accessing the user sentence example dictionary 241 by the input support unit 12 is increased.

Furthermore, the present embodiment is also applicable to documents other than the electronic medical record 231. For example, a document file being edited may be handled in the same manner as the electronic medical record 231 according to the present embodiment, so that sentence examples are output in an order appropriate for each document file.

Specifically, the input support unit 12 searches for a character string matching each sentence example included in the user sentence example dictionary 241, for the document file specified as an editing target (for example, a document file opened in an application). For a sentence example for which a matching character string is found, a priority flag is attached, and this sentence example is prioritized in determining the output order of sentence examples in the list of sentence examples. Accordingly, sentence examples are displayed in an order appropriate for the document file that is the editing target.

That is to say, the document file described above corresponds to the electronic medical record 231 according to the present embodiment. Furthermore, the application corresponds to the electronic medical record editing unit 11 according to the present embodiment.

The contents of the document file are not limited to a predetermined type of document. For example, in the case of a newspaper article, sentence examples are displayed in an order appropriate for contents of an article. In the case of a patent specification, sentence examples are displayed in an order appropriate for the invention described in the specification.

Furthermore, the contents of the document file that is an editing target may be reported to the input support unit 12 by an application for executing the editing of the document file, or the input support unit 12 may actively acquire the contents of the document file. In the former case, for example, the application is to write (record) the contents of the document file that is an editing target in a convenient storage area for the input support unit 12. In the latter case, for example, the input support unit 12 is to acquire the contents of the document file from an application relevant to a window that is set to be active (operation target).

For example, in the present embodiment, the electronic medical record work area may be recorded as a file in a folder that is convenient for the input support unit 12. Accordingly, the versatility of the input support unit 12 is enhanced. That is to say, the input support unit 12 is able to support input of the document without having to consider the top ranking program for editing the document.

The input support unit 12 may obtain the contents of the document file by another method. That is to say, the method of obtaining the contents of the document file that is the editing target performed by the input support unit 12 is not limited to a predetermined method.

Furthermore, the display order of the user sentence example dictionary 241 may be determined by referring to other sentence example dictionaries. For example, the user inputs, as the attribute of a document, a character string that is strongly related to the document to be edited, when starting to edit the document. An example of a character string that is strongly related to the document to be created is the genre or the theme of the document. For example, if the user is a newspaper journalist, a character string relevant to the article to be input as a document may be input.

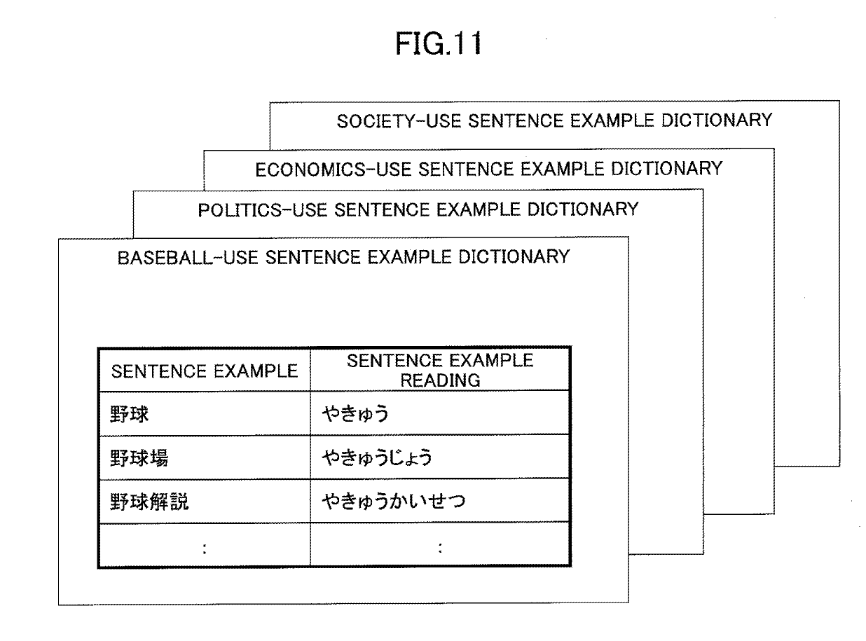

In this case, for example, as illustrated in FIG. 11, a sentence example dictionary is created for each genre of newspaper articles.

FIG. 11 illustrates sentence example dictionaries for each genre. FIG. 11 indicates examples where a baseball-use sentence example dictionary, a politics-use sentence example dictionary, an economics-use sentence example dictionary, and a society-use sentence example dictionary. Each XXX-use sentence example dictionary includes sentence example readings that are strongly related to “XXX”. In FIG. 11, the sentence examples are indicated in the left column in Japanese kanji characters, and sentence example readings are indicated in the right column in Japanese kana characters.

For example, when the user inputs “baseball” as the attribute of the document to be edited, the display order of the user sentence example dictionary 241 of the user is determined by referring to the baseball-use sentence example dictionary. That is to say, in step S203 of FIG. 6, instead of the medical care information, sentence examples included in the baseball-use sentence example dictionary are the search target. Specifically, for each sentence example in the user sentence example dictionary 241, a matching sentence example is searched for in the baseball-use sentence example dictionary. When a matching sentence example is found, a priority flag is attached to the sentence example (of the user sentence example dictionary 241). When no matching sentence examples are found, a priority flag is not attached to any of the sentence examples. Other processing procedures are the same as above. As a result, in the user sentence example dictionary 241, sentence examples strongly related to baseball are displayed at high ranks. Consequently, the operation efficiency is enhanced in editing the document relevant to an article on baseball.

The sentence examples used as a reference in determining the display order of the user sentence example dictionary 241 are not limited to sentence example dictionaries created for different genres and themes as illustrated in FIG. 11. For example, the display order of the user sentence example dictionary 241 of a user B may be determined by referring to the user sentence example dictionary 241 of the user A.

The present invention is not limited to the specific embodiments described herein, and variations and modifications may be made without departing from the scope of the present invention. The embodiments of the present invention are not limited to input support of electronic medical records, and may be applied to input support for other purposes. For example, when a user opens a file and performs an updating/editing operation, the input support device may determine whether a sentence example registered in a user sentence example dictionary is included in the file, and determine the display format of the sentence examples.

According to an aspect of the embodiments, the load of input operations for a document is reduced.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium storing an input support program that causes a computer to execute a process comprising:
acquiring an attribute of a first document that is an input target of a user;
acquiring a second document corresponding to the acquired attribute from a storage unit storing the attribute and the second document relevant to the attribute;
determining whether a sentence example, which is stored beforehand in association with reading information, is included in the second document; and
determining a display format of the sentence example to be displayed together with the first document when a character string included in the reading information is input to the first document by the user, based on a result of the determining of whether the sentence example is included in the second document.

2. The non-transitory computer-readable recording medium according to claim 1, the process further comprising:
displaying a first sentence example in a work area of the first document based on the display format.

3. The non-transitory computer-readable recording medium according to claim 1, the process further comprising:
determining whether the sentence example, which is stored in association with a usage frequency, is included in the second document; and
determining the display format of the sentence example to be displayed together with the first document when the character string included in the reading information is input to the first document by the user, based on the result of the determining of whether the sentence example is included in the second document and the usage frequency.

4. The non-transitory computer-readable recording medium according to claim 1, the process further comprising:
determining whether the sentence example, which is stored in association with a last usage time of the sentence example, is included in the second document; and
determining the display format of the sentence example to be displayed together with the first document when the character string included in the reading information is input to the first document by the user, based on the result of the determining of whether the sentence example is included in the second document and the last usage time.

5. An input support device comprising:
an acquisition unit configured to acquire an attribute of a first document that is an input target of a user, and acquire a second document corresponding to the acquired attribute from a storage unit storing the attribute and the second document relevant to the attribute;
a first determination unit configured to determine whether a sentence example, which is stored beforehand in association with reading information, is included in the second document; and
a second determination unit configured to determine a display format of the sentence example to be displayed together with the first document when a character string included in the reading information is input to the first document by the user, based on a determination result of the first determination unit.

6. A method for performing input support, the method comprising:
acquiring an attribute of a first document that is an input target of a user;
acquiring a second document corresponding to the acquired attribute from a storage unit storing the attribute and the second document relevant to the attribute;
determining whether a sentence example, which is stored beforehand in association with reading information, is included in the second document; and
determining a display format of the sentence example to be displayed together with the first document when a character string included in the reading information is input to the first document by the user, based on a result of the determining of whether the sentence example is included in the second document.
